(19) United States
(12) Patent Application Publication
(10) Pub. No.: US 2018/0178613 A1
(43) Pub. Date: Jun. 28, 2018

(54) SYSTEM AND DEVICE FOR AIR QUALITY MONITORING AND CONTROL ON A TRAIN

(71) Applicant: Broadsens Corp., Milpitas, CA (US)

(72) Inventors: Chang Zhang, San Jose, CA (US); Lei Liu, San Ramon, CA (US)

(73) Assignee: Broadsens Corp., Milpitas, CA (US)

(21) Appl. No.: 15/844,644

(22) Filed: Dec. 18, 2017

Related U.S. Application Data
(60) Provisional application No. 62/439,825, filed on Dec. 28, 2016.

(51) Int. Cl. B60H 1/00; B60H 3/00; G08B 25/01; G08B 21/12; B60H 3/06

(52) U.S. Cl. CPC B60H 1/008; B60H 3/0007; G08B 25/01; B60H 3/06; B60H 3/0085; G08B 21/12; B60H 1/00507

(57) ABSTRACT

The present invention discloses an air quality monitoring device that can measure the hazardous gas contents, including benzene, formaldehyde and VOCs, and other air quality measurements inside train cars in real time. The air quality monitoring device can be installed inside a train car, either in the middle of the car, or at the end, or other locations. Each air quality device is equipped with a unique ID (e.g., MAC address, IP address, and RFID), which can be associated with a car or location inside the train. When hazardous gas level in a train car exceeds the safety level, this car or location can be identified and an air quality control unit injects or sprays photocatalyst material to the air to improve the air quality.

### CROSS-REFERENCE TO RELATED APPLICATION

This application claims priority to U.S. provisional patent application Ser. No. 62/439,825, filed Dec. 28, 2016, the entire content of which is incorporated herein by reference.

### FIELD OF INVENTION

This invention generally relates to the field of indoor air quality monitoring and control.

### BACKGROUND OF THE INVENTION

Passenger trains, including railway trains, subway trains, or trolleys, are important transportation tools in modern world. Internal materials in a train car, such as plastics, rubber, epoxy, glues, paint and sealant, contain hazardous contents, such as benzene, formaldehyde, and other Volatile Organic Compounds (VOCs). The density of the hazardous gases is low in a ventilated environment and is not harmful to human body. Modern trains, however, are usually sealed for temperature control and aerodynamics purposes, and the density of hazardous gases inside a train may reach to a level that cause harms to passengers on board. Long-term exposure to Benzene, formaldehyde and other VOCs may cause nausea, dizziness, and even more severe diseases, such as cancer and bone marrow failure. In addition, fine particulate matter (PM 2.5) density may also be a concern for passengers' health. Although there are monitoring devices for human safety, such as smoke detectors and fire alarms, on trains, there are no devices for monitoring benzene, formaldehyde, volatile organic compounds (VOCs), and other air quality measurements on trains.

### SUMMARY OF THE INVENTION

The present invention discloses an air quality monitoring device that can measure the hazardous gas contents, including benzene, formaldehyde and VOCs, and other air quality measurements inside train cars in real time. In one embodiment of the invention, the air monitoring device has an air pump or fan, an optional air filter, an optional air chamber, at least one air quality sensor, a processing unit (which includes a data acquisition module, a microcontroller, a data storage module, and a communication module), a power supply module, an optional display module, and an optional alarm module.

In one embodiment of the invention, the air quality sensor is a Photoionization Detector (PID), an electrochemical gas sensor, an infrared sensor, a semiconductor sensor, or other types of sensors that can detect benzene, formaldehyde, VOCs and other hazardous gases. In addition, multiple types of air quality sensors may be used to improve detection accuracy, with different types of sensors detect different types of gases.

In yet another embodiment of the invention, when the air quality monitoring device determines that the air quality inside a train car is low, an air quality control unit is used to improve the air quality. The air quality control unit may be connected to the air quality monitoring device and automatically started to improve air quality. Alternatively, both the air quality control unit and the air quality monitoring device may be remotely controlled by a remote console.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the leftmost digit of a reference number identifies the drawing in which the reference number first appears.

FIG. 1 is a structural diagram of an air quality monitoring device for a train car, according to one embodiment of the present invention.

FIG. 2 is a block diagram of a data processing unit of the air quality monitoring device, according to one embodiment of the present invention.

FIG. 3 is a block diagram of a data acquisition module, according to one embodiment of the present invention.

FIG. 4 is a block diagram of a train air quality monitoring and control system, according to one embodiment of the present invention.

### DETAILED DESCRIPTION

The present invention discloses an air quality monitoring device that can measure the hazardous gas contents, including benzene, formaldehyde and VOCs, and other air quality measurements inside train cars in real time. The air quality monitoring device can be installed inside a train car, either in the middle of the car, or at the end, or other locations. Each air quality device is equipped with a unique ID (e.g., MAC address, IP address, and RFID), which can be associated with a car or location inside the train. When hazardous gas level in a train car exceeds the safety level, this car or location can be identified. The air quality device can be mounted with screws, clamps, or other methods.

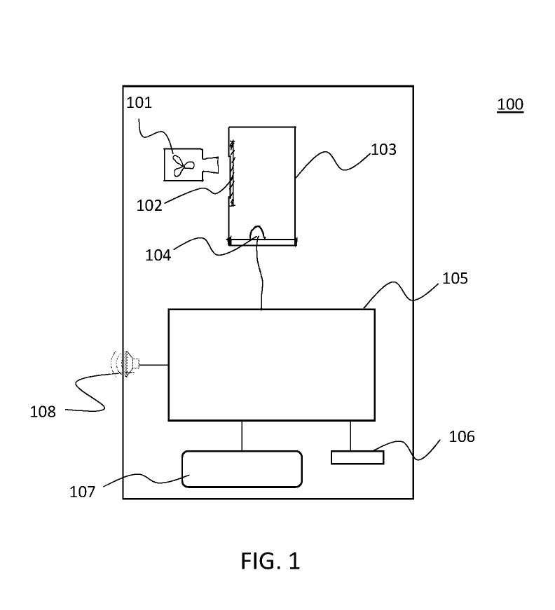

As shown in FIG. 1, the air monitoring device 100 has an air pump or fan 101, an air filter 102, an air chamber 103, at least one air quality sensor 104, a data processing unit 105 (which includes a data acquisition module, a microcontroller, a data storage module, and a communication module), a power supply module 106, a display module 107, and an alarm module 108. It should be noted that certain components, such as the air filter 102, the air chamber 103, the display module 107, and the alarm module 108, may be optional. The air quality sensor 104 can measure one or more air quality measurements, including benzene, formaldehyde, VOCs, or other hazardous gases. Although FIG. 1 shows that the various components of the air monitoring device 100 are housed in one device housing, there may be separate housings for the components so that the air quality sensor 104 and the processing unit 105 may be installed at different locations.

The air pump or fan 101 is used to increase the air circulation to monitor a large area. The air pump or fan 101 can draw air from farther away locations to the air quality sensor for checking. The air filter 102 is installed in front of the air quality sensor 104. The air filter 102 is used to filter out dust or other elements that may affect the detection accuracy and service life of the air quality sensor 104.

In some cases, the air chamber 103 is used to contain air for special treatment before measurement. For example, when the air quality sensor 104 is a Photoionization Detector (PID), a UV lamp is used to emit high-energy photons into the air of monitored area, e.g., the air chamber 103. The UV lamp can be 10.6eV, 11.7eV or other types. As air flows into the air chamber 103, compounds in the air are bombarded by the high-energy UV photons and are ionized after absorbing the UV light, causing the ejection of electrons and the formation of positively charged ions. The ions produce an electric current, which is further used to measure the air quality.

In another embodiment of the invention, the air quality sensor 104 is an electrochemical gas sensor. The measured air diffuses into the sensor to the working electrode where it is oxidized. This electrochemical reaction results in an electric current, which is further used to measure the gas density.

In other embodiments of the invention, the air quality sensor can be infrared sensor, semiconductor sensor, or other types of sensors, that can detect benzene, formaldehyde, and other VOCs.

Although only one air quality sensor 104 is shown in FIG. 1, multiple types of air quality sensors may be used to improve detection accuracy, with different types of sensors detect different types of gases.

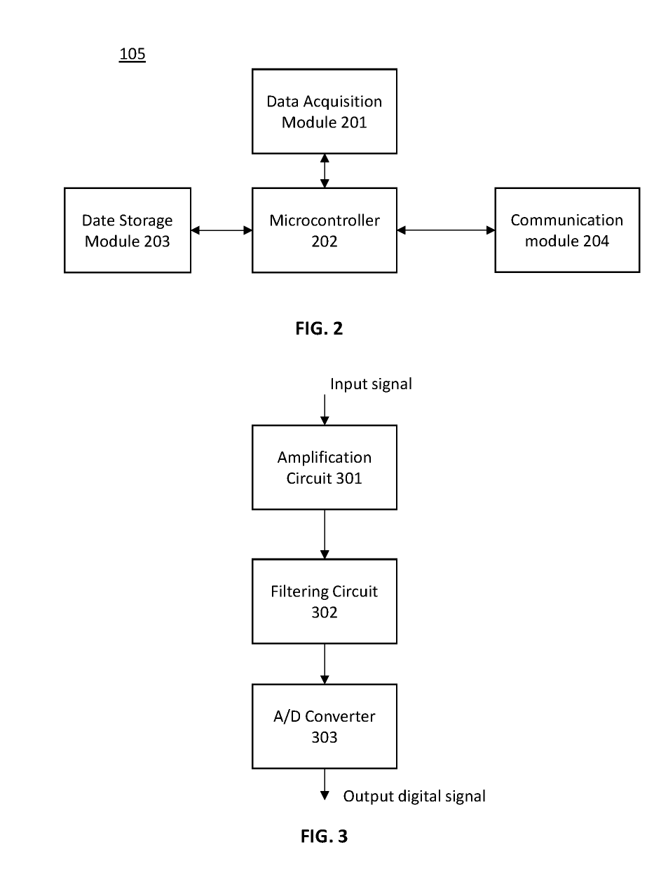

FIG. 2 is a block diagram of a data processing unit of the air quality monitoring device, according to one embodiment of the present invention. As shown, the data processing unit 105 includes a data acquisition module 201, a microcontroller 202, a data storage module 203, and a communication module 204. During operation of the air quality monitoring device 100, the data acquisition module 201 receives signals from the air quality sensor(s) 104 and converts the signals, if they are analog, into digital sensor data for processing by the microcontroller 202.

Specifically, FIG. 3 shows the details of the data acquisition module 201. In one embodiment, the data acquisition module 201 includes an amplification circuit 301, a filtering circuit 302, and at least one A/D converter 303. In one embodiment, the amplification circuit 301 converts the current output from the air quality sensor 104 into voltage and amplifies the analog signal generated by the air quality sensor 104 to increase the signal level. In another embodiment, the amplification circuit 301 directly amplifies the output voltage from the air quality sensor 104 to a desired level for the A/D converter. In yet another embodiment, the amplification circuit 301 can have an adjustable gain to adjust the measurement level of the signal, so that different gas levels can be measured. The filtering circuit 302 is optional. It can be a high-pass filter, low-pass filter or a bandpass filter to remove unwanted electrical noise. The signal can be further filtered by going through an anti-aliasing filter in front of the A/D converter 303 to remove high frequency noise. The A/D converter converts analog signal to digital sensor data for processing by the microcontroller 202.

The microcontroller 202 calculates the air quality, including gas type and density based on the sensor data. In one embodiment, a baseline gas data is obtained through calibration and gas density is calculated by comparing the new data with the baseline data. The microcontroller 202 may also control the air pump or fan 101 (e.g., turning on or off) and the data acquisition module 201. The microcontroller 202 can configure the parameters of the A/D converter 303 including the sampling rate, input range, and number of samples. The microcontroller 202 can also control the amplification circuit 301, when there is an adjustable gain amplifier to adjust the analog signal amplification level.

The data storage module 203 stores sensor data, calibration data, and calculated air quality data. The car and location information of the air quality monitoring device 100 can also be stored in the storage module 203. The display module 107 is optional. It can show the status of the device as well as air quality sensor status, gas density data, and air quality status. In one embodiment of the invention, a different color icon is displayed to indicate the air quality to be normal, warning, or hazardous. In another embodiment of the invention, numeric and textual display is used to show the levels of benzene, formaldehyde or other VOCs. The display can be turned on and turned off remotely from the remote console on the train.

The alarm module 108 is optional as well. It sends alarm notifications in hazardous conditions. The alarm can be a speaker or siren. The alarm can be turned on and turned off remotely from the console on the train.

The power supply module 106 can draw power from the train or other power supply. A DC-DC or AC-DC converter is used to convert the train voltage to the voltage that the monitoring device uses. In one example, the train voltage is 24V DC. The voltage of the device can be 5v, 3.3V or other voltage level. In another example, the train voltage can be 110 v or 220 v, in which case an AD-DC converter is used to convert the voltage level to the desired level such as 5 v or 3.3 v. Alternatively, the device may also be powered by a battery.

The gas detection accuracy can be affected by the environment and sometimes it is necessary to take environment into consideration. In one embodiment of the invention, a temperature sensor is included in the air quality monitoring device 100. The temperature sensor can be used to provide the environment information and to calibrate the gas detection. For example, gas sensor output can be affected by different temperature level. A formula is used to calculate the gas level with an input factor of the temperature. The formula can be obtained by measuring the output at different temperatures and a function can be established by associating the output with the temperature.

In another embodiment of the invention, a humidity sensor is included in the air quality monitoring device 100. The humidity sensor can be used to provide the environment information and to calibrate gas detection. For example, gas sensor output can be affected by different humidity level. A formula is used to calculate the gas level with an input factor of the humidity. The formula can be obtained by measuring the output at different humidity and a function can be established by associating the output with the humidity.

The communication module 204 is used to communicate with the remote console located on or off the train. The communication module 204 sends air quality measurement data to and receives commands from the remote console. The communication interface can be either wired or wireless. The wired interface can be Ethernet, CAN, RS485, RS232, USB, or other types of interfaces. The wireless interface can be Wi-Fi, ZigBee, mobile data, or other types of interfaces.

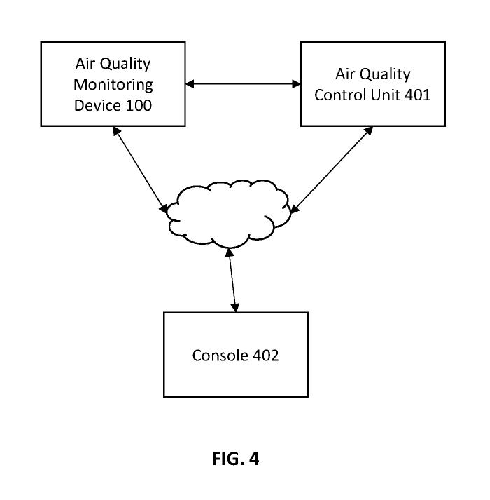

In another embodiment of the invention, as shown in FIG. 4, when the air quality monitoring device 100 detects that the hazardous gas density exceeds a safety level, it sends a signal to an air quality control unit 401 to improve the air quality. Alternatively, the air quality control unit 401 can periodically communicate with the air monitoring device 100 to obtain air quality measurement data. The communication may be carried via wired (e.g., Ethernet, CAN, RS485, RS232, USB) or wireless means (e.g., Wi-Fi, ZigBee, mobile data). In one embodiment of the invention, the air quality control unit 401 injects or sprays photocatalyst material to the air. Although the air quality control unit 401 is shown as a separate device (which has its own microcontroller, communication module, memory module, etc.) from the air quality monitoring device 100, it can also be integrated to the air quality monitoring device 100 and become an integrated air quality monitoring and control device.

Also, as shown in FIG. 4, both the air quality monitoring device 100 and the air quality control device 401 can communicate with a remote console 402 via a dedicated network or the Internet. The air quality monitoring device 100 sends air quality measurement data to the console 402. The console 402 can remotely control both the air quality monitoring device 100 and/or the air quality control unit 401.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A train air quality monitoring device, which is mounted inside a train car, comprises:
at least one air quality sensor;
at least one air pump or fan;
a data acquisition module;
a microcontroller;
a storage module; and
a communication module.

2. The device of claim 1, wherein each of said at least one air quality sensor is a Photoionization Detector (PID), electrochemical sensor, infrared sensor, catalytic sensor, or semiconductor sensor.

3. The device of claim 1, wherein said data acquisition module comprises an amplification circuit and at least one A/D converter.

4. The device of claim 1, wherein said device has a unique ID, which is associated with a location where it is mounted.

5. The device of claim 1, wherein said communication module includes a digital interface from one of Ethernet, CAN bus, RS485, RS232, USB, Wi-Fi, ZigBee, and mobile data.

6. The device of claim 1, wherein said device includes an air filter to filter out disturbances to the at least one air quality sensor.

7. The device of claim 1, wherein said device includes an air chamber to contain measured air.

8. The device of claim 1, wherein said device includes a display.

9. The device of claim 8, wherein said display is controlled remotely, including being turned on or off.

10. The device of claim 1, wherein said device includes an alarm that can be turned on or off remotely.

11. The device of claim 1, wherein said device is powered by a power supply from the train through a voltage converter and the voltage converter can be either a DC-DC converter or an AC-DC converter, and wherein said device further includes a backup battery as a backup power source.

12. The device of claim 1, wherein said device is powered by a battery.

13. The device of claim 1, wherein said device uses a conversion formula to convert digital sensor data to density of at least one type of gas.

14. The device of claim 1 further includes an air quality control unit which is used to improve air quality when the device detects that the air quality is below a safe level, and wherein the air quality control unit improves air quality by spraying photocatalyst material to the air.

15. A system for monitoring train air quality, the system comprising:
a plurality of train air quality monitoring devices, each device comprising:
at least one air quality sensor;
at least one air pump;
a data acquisition module;
a microcontroller;
a storage module; and
a communication module; and
a remote management console, wherein the console sends instructions to the plurality of train air quality monitoring devices and receives air quality results from these devices via a network.

16. The system of claim 15 further includes a plurality of train air quality control units for improving air quality, wherein the console further sends instructions to the plurality of train air quality control units via a network.

17. The system of claim 16, wherein each train air quality monitoring device has a unique ID associated to a location where the corresponding air quality monitoring device is mounted.
